(19) United States
(12) Patent Application Publication
(10) Pub. No.: US 2008/0046772 A1
(43) Pub. Date: Feb. 21, 2008

(54) SHIFTING INACTIVE CLOCK EDGE FOR NOISE REDUCTION

(75) Inventors: Igor Arsovski, Williston, VT (US); Joseph A. Iadanza, Hinesburg, VT (US); Jason M. Norman, Essex Junction, VT (US); Hemen Shah, South Burlington, VT (US); Sebastian T. Ventrone, South Burlington, VT (US)

Correspondence Address: HOFFMAN, WARNICK & D'ALESSANDRO LLC, 75 STATE ST, 14TH FLOOR, ALBANY, NY, 12207, US

(73) Assignee: INTERNATIONAL BUSINESS MACHINES CORPORATION, Armonk, NY (US)

(21) Appl. No.: 11/457,916

(22) Filed: Jul. 17, 2006

(51) Int. Cl. G06F 1/00

(52) U.S. Cl. 713/500

(57) ABSTRACT

A method and system for reducing clock noises are disclosed. A clock signal includes active edges and inactive edges. Inactive edges produce clock noise but are not critical to the functionality of the clock signal. That is, only active edges are critical to proper timing of an integrated circuit (IC). As such, inactive edges of clock signals to clocked elements of an IC may be shifted to be misaligned to one another. As a consequence, peak noise produced by the inactive edges will be spread over a large area and therefore will be reduced in amplitude.

### FIELD OF THE INVENTION

The invention relates generally to an integrated circuit, and more particularly, to a method and system for shifting inactive clock signal edges for reducing noise level.

### BACKGROUND ART

In a typical integrated circuit (IC), clock nets are heavily loaded, and typically need to have very tight tolerance, which results in large drive strengths of the buffers in, e.g., the clock tree. An IC design may use both edges (leading edge and falling edge) of a single clock. For example, a double data rate (DDR) interface uses both edges of a clock to achieve the desired functionality. However, for general data transfer using generic logic resources, an IC uses only one edge of a single clock, usually the leading edge. For example, current state of the art clock generators and methods of distributing a clock tree typically have four edges for a two-phase clock cycle, i.e., a launch edge, a capture edge, and two opposite transition edges of the two phase clock. The critical edges are the launch edge and the capture edge, which are used to maintain the functionality of the clock signal, e.g., a proper timing. However, the inactive edges, e.g., the two opposite transition edges are not used for functional purpose, they contribute in creating power supply noise. As shown in FIG. 1, each inactive clock edge 110 may creates noise spike 112 as active edges 114 do. Given that inactive edges are not critical to the functionality of a clock signal, the parasitic noise caused by the inactive edges is less tolerable.

As such, there is a need in the art to manipulate inactive clock edges to reduce clock noise within the silicon of an IC. The present state of the art technology does not provide a satisfactory solution to this need.

### SUMMARY OF THE INVENTION

A method and system for reducing clock noise is disclosed. A clock signal includes active edges and inactive edges. Inactive edges produce clock noise but are not critical to the functionality of the clock signal. That is, only active edges are critical to proper timing of an integrated circuit (IC). As such, inactive edges of clock signals to clocked elements of an IC may be shifted to be misaligned to one another. As a consequence, peak noise produced by the inactive edges will be spread over a large area and therefore will be reduced in amplitude.

A first aspect of the invention provides a method of reducing clock noise generated by clock signals in an integrated circuit (IC), the method comprising: providing an IC with multiple clocked elements, clock signals to the multiple clock elements being generated from a general clock signal; and shifting clock signals of the multiple clocked elements such that the clock signals of the multiple clocked elements have aligned active edges and misaligned inactive edges to reduce the clock noise generated by the inactive edges of the clock signals.

A second aspect of the invention provides a system of reducing clock noise generated by clock signals in an integrated circuit (IC), the system comprising: means for providing a general clock signal; means for splitting the general clock signal to generate multiple local clock signals for multiple clocked elements of the IC; and means for shifting the local clock signals such that the local clock signals have aligned active edges and misaligned inactive edges to reduce the clock noise generated by the inactive edges of the local clock signals.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a clock signal and noise spikes generated by the clock signal according to known art.

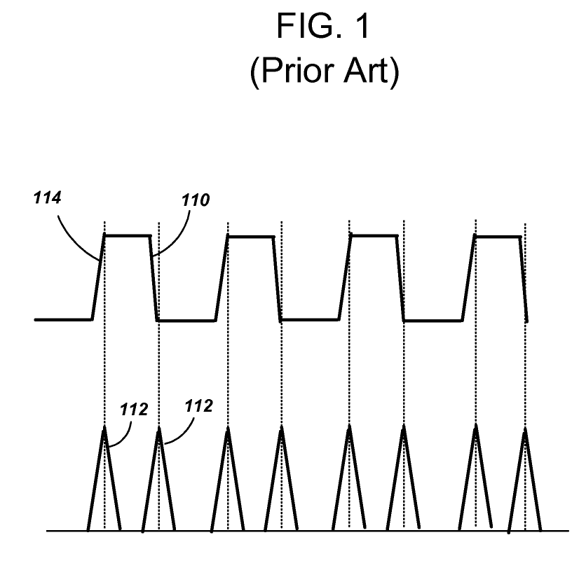

FIG. 2 shows the effect of misaligned inactive clock edges of clock signals on the peak current generated by the inactive clock edges according to one embodiment of the invention.

FIG. 3 shows a schematic diagram of a clock path circuit according to one embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

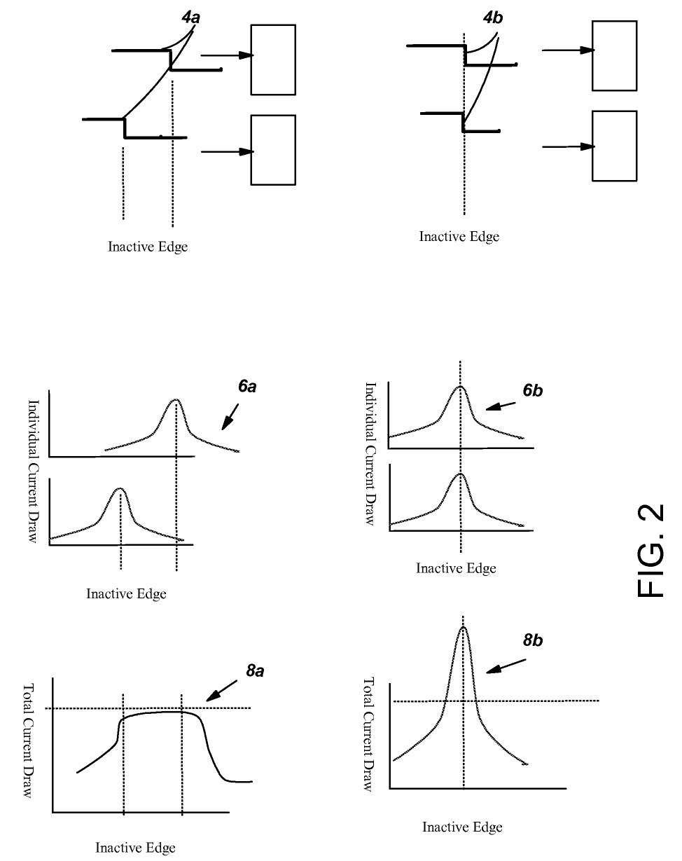

The current invention is based on an understanding that if two noise spikes are closer in time, the peak current will be higher in magnitude. On the other hand, if two noise spikes are separated relatively far away in time, the peak current will be lower in magnitude. As such, if clock signals of clocked elements, e.g., latches, SRAMs, flipflops, register files, or other data storage elements, have misaligned/non-coincident inactive edges in time, the peak current generated by the inactive edges will be reduced. As shown in FIG. 2, clocks 4a with misaligned inactive edges generate individual currents 6a with misaligned individual peaks, which results in reduced total peak current 8a, compared with that of total current 8b generated by clocks 4b with aligned inactive edges. In FIG. 2 and the following description, the falling edge of a single clock is used as an illustrative example of an inactive edge, which represents the ordinary clock signal design. However, using the leading edge as an inactive edge is also possible and is included in the scope of the current invention.

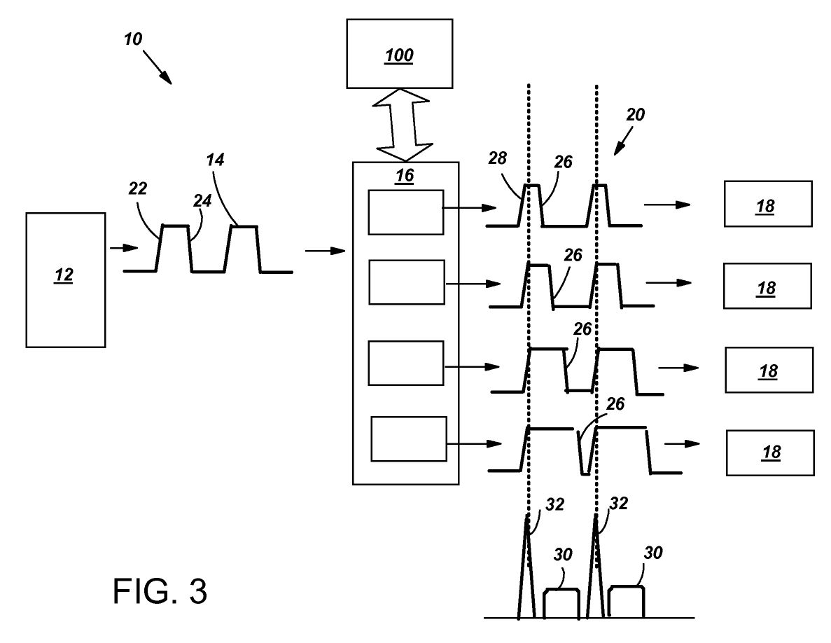

FIG. 3 shows a schematic diagram of a clock path circuit 10 according to one embodiment of the invention. As shown in FIG. 3, a clock generator 12 generates a global clock (CLK_G) 14. CLK_G 14 is propagated to a local clock chopper (LCC) 16 before a local clocked element 18. Local clock chopper 16 processes/splits global clock 14 and generates a local clock 20 for each local clocked element 18. As is appreciated, clock structure of an IC may be much more complicated than the example of FIG. 3. However, the invention can be applied to all kinds of clock structures. As such, it should be appreciated that a local clocked element 18 may include/represent any clocked elements or groups of clocked elements in an IC, and a local clock 20 may represent any clock signal (i.e., leaf in a clock tree) or a branch of clock signal (i.e., a branch of a clock tree or a clock tree) in a treed clock propagation structure.

In operation, local clock chopper 16 maintains active edges 22 of global clock 14 in the splitting, but shifts inactive edge 24 of global clock 14 to generate local clocks 20. As shown in the illustrative example of FIG. 3, local clocks 20 have inactive edges 26 misaligned to one another. At the same time, local clocks 20 have aligned active edges 28. As such, proper timing of local clocked elements 18 is maintained, while peak current 30 (noise) generated by the inactive edges 26 is reduced compared with peak current 32 generated by active edges 28. According to one embodiment, local clock chopper 16 shifts/distributes inactive edge 26 of local clock signal 20 for each local clocked element 18 in across a period of local clock signal 20. It should be appreciated that any now known or later developed methods or mechanisms may be used to effect the shifting of inactive edges 26, and all are included in the scope of the invention. It should also be appreciated that it is not necessary that all local clocks 20 have misaligned inactive edges 26. A group of local clocks 20 may have substantially aligned inactive edges 26.

According to one embodiment, local clock chopper 16 may be controlled by a control system 100, e.g., a computer system. For example, control system 100 may select local clock signals 20 for inactive edge shifting and may determine how an inactive edge 22 of a local clock signal 20 should be shifted. In other words, control system 100 determines and assigns a clock duty cycle for each local clock 20. It is appreciated that in assigning a clock duty cycle, active edge 28 is not varied such that proper timing of the IC is maintained. Any methods or standards/tests may be used in the assignment of clock duty cycle, and all are included in the current invention. Basically, to reduce noise, inactive edges of local clocks 20 need to be as misaligned as possible, provided that other design rule constraints are met.

In addition, in the case that a large number of local clocks 20 are involved, weightings may be applied to local clocks 20 in the clock duty cycle assignment. It is appreciated that it is the switching of inactive edges 26 of local clocks 20, not the activities of local clocked elements 18, that generates noise currents at inactive edges. For example, a local clock 20 (e.g., a branch or clock signal leaf) that has the potential to generate more noise may be assigned a priority in the assignment of clock duty cycle. Specifically, clock signals which drive larger numbers of clocked elements need to be assigned higher priority in order to maximize spreading of inactive edges and minimize peak noise. In addition, a local clock signal with a capacitive load higher than a pre-set threshold is may also be assigned a priority. In general clock signals may be evaluated for their potential to create noise due to inactive edge switching and regardless of the cause of the noise generation potential, those clock signals with the highest potential for noise generation or those which potentially generate noise above a pre-set threshold for acceptable noise generation may be prioritized above other clock signals in the IC for clock duty cycle spreading.

In addition, the assignment of a clock duty cycle may involve the consideration of the noise sensitive bandwidth of a nearby circuit such that an inactive edge 26 of a local clock signal 20 falls outside of the noise sensitive bandwidth. For example, if a nearby circuit is sensitive to noise at the middle of a clock cycle, the local clock signal 20 of a clocked element 18 needs to have a clock duty cycle skewed away from 50/50, i.e., inactive clock edge in the middle of a clock cycle.

Moreover, as a functionality requirement, the assigned clock duty cycle needs to leave enough time for a local clocked element 18 to complete data processing. In other words, the shifted clock duty cycle must maintain the minimum pulse-width requirement of the respective clocked element 18. For example, if a local clocked element 18 needs a 20/80 clock duty cycle to complete a data transition, the respective local clock 20 cannot be assigned a clock duty cycle of 10/90.

In addition, it needs to be determined whether the assignment of clock duty cycles maintains proper functionality of the designed IC. For example, it needs to be determined whether, after the shifting of inactive clock edges, the clocked elements are able to be placed and routed according to design rule constraints. Other timing constraints, such as the above-mentioned clock pulse-width, also need to be checked and maintained.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of reducing clock noise generated by clock signals in an integrated circuit (IC), the method comprising:
providing an IC with multiple clocked elements, clock signals to the multiple clock elements being generated from a general clock signal; and
shifting clock signals of the multiple clocked elements such that the clock signals of the multiple clocked elements have aligned active edges and misaligned inactive edges to reduce the clock noise generated by the inactive edges of the clock signals.

2. The method of claim 1, further comprising assigning a clock duty cycle to a clock signal of a clocked element such that there is enough time for the clocked element to complete a data processing function.

3. The method of claim 1, further comprising assigning a clock duty cycle to a clock signal of a clocked element such that an inactive edge of the clock signal falls outside of a bandwidth within which a nearby circuit is sensitive to noise.

4. The method of claim 1, further comprising assigning a clock duty cycle to a clock signal of a clocked element based on a potential amount of noise produced by inactive edges of the clock signal.

5. The method of claim 1, further comprising selecting clock signals for clock signal shifting and duty cycle assignment based on their priority.

6. The method of claim 5, wherein a priority of the clock signal is determined based on a potential of the clock signal to produce noise.

7. The method of claim 6, wherein a clock signal that has the potential to produce noise in switching inactive edges more than a threshold is assigned a priority.

8. The method of claim 7, wherein a clock signal with a capacitive load higher than a pre-set threshold is assigned a priority.

9. The method of claim 1, further comprising distributing the inactive edge of the clock signal for each of the clocked elements in the IC across a period of the clock signal.

10. A system of reducing clock noise generated by clock signals in an integrated circuit (IC), the system comprising:
means for providing a general clock signal;
means for splitting the general clock signal to generate multiple local clock signals for multiple clocked elements of the IC; and
means for shifting the local clock signals such that the local clock signals have aligned active edges and misaligned inactive edges to reduce the clock noise generated by the inactive edges of the local clock signals.

11. The system of claim 10, further comprising means for assigning a clock duty cycle to a local clock signal of a clocked element such that there is enough time for the clocked element to complete a data processing function.

12. The system of claim 10, wherein the assigning means assigns a clock duty cycle to a local clock signal such that an inactive edge of the local clock signal falls outside of a bandwidth within which a nearby circuit is sensitive to noise.

13. The system of claim 10, wherein the assigning means assigns a clock duty cycle to a local clock signal based on a potential amount of noise produced by inactive edges of the local clock signal.

14. The system of claim 10, wherein the assigning means assigns a clock duty cycle to a local clock signal based on a priority of the clock signal.

15. The system of claim 14, wherein the priority of the local clock signal is determined based on a potential of the local clock signal to produce noise.

16. The system of claim 15, wherein a local clock signal that has the potential to produce noise in switching inactive edges more than a threshold is assigned a priority.

17. The system of claim 16, wherein a local clock signal with a capacitive load higher than a pre-set threshold is assigned a priority.
